(19) United States
(12) Patent Application Publication
(10) Pub. No.: US 2016/0205931 A1
(43) Pub. Date: Jul. 21, 2016

(54) SEX PHEROMONE DERIVATIVES, AND METHODS AND USES THEREOF

(71) Applicant: Her Majesty the Queen in Right of Canada, as rep. by the Minister of Natural Resources Canada, Ottawa (CA)

(72) Inventors: Peter SILK, Fredericton (CA); Krista RYALL, Sault Ste. Marie (CA); Peter MAYO, Durham Bridge (CA); David MAGEE, Gagetown (CA)

(21) Appl. No.: 14/994,752

(22) Filed: Jan. 13, 2016

Related U.S. Application Data
(60) Provisional application No. 62/104,649, filed on Jan. 16, 2015.

(51) Int. Cl. A01N 43/22

(52) U.S. Cl. CPC A01N 43/22

(57) ABSTRACT

The present disclosure discusses dodecan-12-olide, and formulations thereof, and its use in detection surveys of, and in mitigation methods for, Emerald Ash Borer beetle infestations of Ash trees.

### CROSS REFERENCE TO RELATED APPLICATIONS

This application claims the benefit of priority of U.S. Provisional Patent Application No. 62/104,649 filed Jan. 16, 2015, which is hereby incorporated by reference.

### FIELD

The present disclosure relates to biologically active analogs of Emerald Ash Borer sex pheromones.

### BACKGROUND

The following paragraphs are not an admission that anything discussed in them is prior art or part of the knowledge of persons skilled in the art.

The Emerald Ash borer, Agrilus pianipennis (EAB) ((Coleoptera: Buprestidae), is an invasive species causing unprecedented levels of mortality to Ash trees in its introduced range. The natural sex pheromone of EABs is the female-produced macrocyclic lactone (3Z)-dodecen-12-olide, whose structure is shown below:

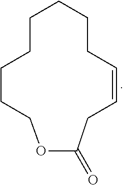 [SMILES: O=C1C/C=C\CCCCCCCCO1]

The natural sex pheromone can be used as a lure for detection surveys, as well as for mitigation purposes, such as through mating disruption. However, the natural sex pheromone is costly to synthesize, involving multistep, low-yielding processes.

### INTRODUCTION

The following introduction is intended to introduce the reader to this specification but not to define any invention. One or more inventions may reside in a combination or sub-combination of the apparatus elements or method steps described below or in other parts of this document. The inventors do not waive or disclaim their rights to any invention or inventions disclosed in this specification merely by not describing such other invention or inventions in the claims.

Green prism traps placed in the Ash tree canopy, baited with both (3Z)-dodecen-12-olide and (3Z)-hexenol, showed an increase in captures of EAB males by up to 100% compared with traps baited with (3Z)-hexenol alone. Additional studies also demonstrated that addition of (3Z)-dodecen-12-olide to green traps baited with (3Z)-hexenol not only increased trap captures, but also detection rates (i.e., the proportion of traps that captured at least one EAB). These results indicate that (3Z)-dodecen-12-olide has the potential to be used in early detection surveys for EAB, or as a component of an attractant for a trap.

A problem associated with using (3Z)-dodecen-12-olide is that the chemical synthesis involves multiple, low yielding steps, and results in an expensive compound. Therefore, there remains a need for a more easily and/or more cheaply produced analog of (3Z)-dodecen-12-olide where the analog has comparable biological activity to the natural sex pheromone.

The authors of the present disclosure have surprisingly identified dodecan-12-olide as a biologically active analog to the natural, female-produced (3Z)-dodecen-12-olide EAB sex pheromone. The structure of dodecan-12-olide is shown below:

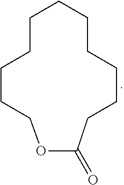 [SMILES: O=C1CCCCCCCCCCCO1]

Dodecan-12-olide can thus provide a less expensive compound, in comparison to the natural sex pheromone, which may be used, for example: as a component in an attractant for EAB detection surveys, as a component in an attractant for a trap, as a component in an attractant to draw EABs to non-host trees, as a component in an attractant to draw EABs to Ash trees treated with an insecticide, or any combination thereof.

If applied in sufficient quantities, dodecan-12-olide may be used to reduce the ability of male EABs to locate a mate, or to disrupt male EAB orientation, thereby disrupting the ability for male EABs to mate. Mating disruption may reduce the rate of EAB spreading, reduce the rate of Ash tree mortality caused by EAB, or both. In the context of the present disclosure, reducing the rate of Ash tree mortality refers to reducing the rate that a population of Ash trees is infected and killed by EABs.

In some embodiments, dodecan-12-olide exhibits at least 70% of the activity of the natural sex pheromone under comparable conditions. In particular embodiments, dodecan-12-olide exhibits at least 80% of the activity of the natural sex pheromone. In yet other particular embodiments, dodecan-12-olide exhibits at least 90% of the activity of the natural sex pheromone.

In some embodiments, the present disclosure provides an attractant that includes dodecan-12-olide and a green leaf volatile, such as (3Z)-hexenol.

In other embodiments, the present disclosure provides dodecan-12-olide for use as a sex pheromone analog for EABs. In still other embodiments, the present disclosure provides the use of dodecan-12-olide as a sex pheromone analog for EABs.

Dodecan-12-olide may be used as a sex pheromone analog to attract a male EAB, or to overwhelm the male EAB's ability to locate a female EAR. When overwhelming the male EABs ability to locate a female EAB, it is desirable to use sufficient dodecan-12-olide to substantially saturate the receptors of the male EABs. Attracting male EABs using dodecan-12-olide, or overwhelming their ability to detect female EABs, may disrupt the ability for the male EABs to locate a female EAB. A reduced ability to locate a mate may reduce the rate of EAB spreading, or the rate of Ash tree mortality caused by the EABs. Attracting male EABs using dodecan-12-olide may be used in an EAB detection survey.

Methods according to the present disclosure may be used to disrupt EAB mate location, reduce the rate of EAB spreading, capture EABs, or any combination thereof.

In an exemplary embodiment, the present disclosure provides a method for overwhelming the male EABs ability to locate a female EAB. The method includes administering a composition that comprises dodecan-12-olide to at least a portion of an Ash tree, in the canopy of an Ash tree, or any combination thereof. The dodecan-12-olide may be sprayed on the Ash tree, or high release-rate lures may be placed in the canopy of the Ash tree.

In another exemplary embodiment, the present disclosure provides a method for attracting a male EAB. The method includes placing an attractant that includes dodecan-12-olide and a green leaf volatile, such as (3Z)-hexenol, in a canopy of an Ash tree, or in or near a non-host tree. The Ash tree may be treated with insecticide, such as a trunk-injected systemic insecticide. Mating and laying eggs in the non-host tree may be fatal to at least some of the resulting larva.

In a further exemplary embodiment, the present disclosure provides a method that includes: masking one or more Ash trees from EAB detection using a chemical masking agent on, in or near the one or more Ash trees, and attracting the EABs to a trap, or to an Ash tree lacking the masking agent but treated with insecticide. The attracting may be achieved using an attractant that includes dodecan-12-olide and a green leaf volatile. The chemical masking agent may be a conifer volatile compound, such as a volatile compound from a spruce tree. Specific examples of a spruce volatile compound that may be used include: α-pinene, β-pinene, 3-carene, limonene, α-terpinolene, or a combination thereof. The insecticide may include azadirachtin, emamectin benzoate, imidacloprid, dinotefuran, permethrin, bifenthrin, cyfluthrin, carbaryl, or a combination thereof. Other insecticides or conifer volatile compounds known in the art may also be used.

In another exemplary method, the method includes: disrupting male EAB orientation using a plurality of high release-rate lures that release dodecan-12-olide, and attracting the male EABs to traps baited with an attractant that includes dodecan-12-olide and a green leaf volatile. Disrupting male EAB orientation using high release-rate lures may be achieved by positioning the high release-rate lures in the canopy of the Ash tree, and preferably around the trap. Alternatively, the male EABs may be attracted to an Ash tree that is treated with an insecticide, or to a non-host tree.

Dodecan-12-olide may be synthesized, for example, via Mitsunobu esterification of a saturated ω-hydroxy acid, or via a Baeyer-Villiger oxidation of the commercially available cyclododecanone.

### BRIEF DESCRIPTION OF THE DRAWINGS

Embodiments of the present disclosure will now be described, by way of example only, with reference to the attached Figures.

FIG. 1 is an illustration of a synthetic scheme for making dodecan-12-olide.

FIG. 2 is an illustration of a synthetic scheme for making dodecan-12-olide.

FIG. 3 is an illustration of a synthetic scheme for making (2E)-dodecen-12-olide.

FIG. 4 is a graph illustrating the results of electroantennography testing of dicholormethane (DCM), (3E)-dodecen-12-olide (also referred to herein as “(3E)-lactone”), (3Z)-dodecen-12-olide (also referred to herein as “(3Z)-lactone”), and dodecan-12-olide.

FIG. 5 is a graph illustrating the results of olfactometer responses of male EABs to (3E)-lactone, (3Z)-lactone, and dodecan-12-olide.

FIG. 6 is a graph illustrating the results of olfactometer responses of female EABs to (3E)-lactone, (3Z)-lactone, and dodecan-12-olide.

FIG. 7 is a graph illustrating the results of three field trials testing green sticky prism traps baited with (3Z)-hexenol alone or combined with either (3Z)-lactone or dodecan-12-olide.

FIG. 8 is a graph illustrating the results of a field trial testing and determining whether the location of the trap in the Ash tree canopy has an effect on the number of captured EABs.

FIG. 9 is a graph illustrating the results of a test to determine whether different light conditions affect the number of EAB calls.

FIG. 10 is a graph illustrating the results of a field trial testing whether four high release-rate disrupter lures treated with the (3Z)-lactone could push EABs towards a trap baited with (3Z)-hexenol and (3Z)-lactone.

FIG. 11 is a graph illustrating the results of a field trial testing whether seven high release-rate disrupter lures treated with the (3Z)-lactone could push EABs towards a trap baited with (3Z)-hexenol and (3Z)-lactone.

FIG. 12 is a graph illustrating the results of a field trial testing whether volatile spruce compounds could be used to mask traps baited with (3Z)-hexenol and (3Z)-lactone.

### DETAILED DESCRIPTION

The natural sex pheromone (3Z)-dodecen-12-olide and its geometrical isomer, (3E)-dodecen-12-olide, are both electroantennogram (EAG) active. Both compounds, in combination with (3Z)-hexenol, effectively trap EABs (mostly males) in green prism traps deployed in the Ash tree canopy. The structure of (3E)-dodecen-12-olide is shown below:

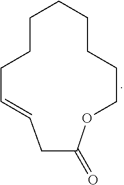 [SMILES: O=C1C/C=C/CCCCCCCCO1]

Chemoreceptors are very highly compound specific, as discussed by Xu et al, in 2012 (Xu P. Garczynsk, S F, Atungulu E, Syed Z, Choo Y-M, Vidal D M, Zitelli C H, Leal, W S (2012) Moth sex pheromone receptors and deceitful parapheromones. PLOS One 7: 1-9). In an effort to identify biologically active analogs of the (3Z)-lactone, the authors of the present disclosure tested various cyclic lactone esters. Examples of tested analogs include: 2E-dodecan-12-olide, pentadecan-15-olide, and dodecan-12-olide. The structures of 2E-dodecan-12-olide, pentadecan-15-olide, and dodecan-12-olide are shown below:

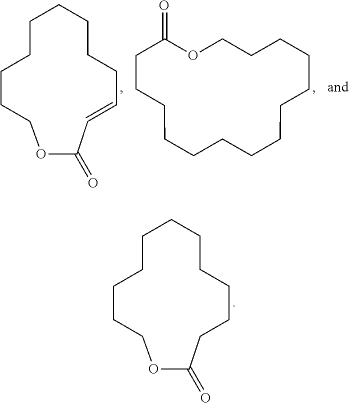

While 2E-dodecan-12-olide and pentadecan-15-olide were found to have electroantennogram activity with male or female EABs that was not significantly different from the controls, it was surprisingly found that dodecan-12-olide showed electroantennogram activity with both male and female EABs that was comparable to the corresponding electroantennogram activity both the natural (3Z)-lactone and the (3E)-lactone analog.

Given the lack of electroantennogram activity with 2E-dodecan-12-olide and pentadecan-15-olide, it would not have been possible to predict a priori the activity of dodecan-12-olide. The activity of dodecan-12-olide in bioassays confirmed that the compound could be used as a sex pheromone analog.

In some examples, the present disclosure provides an attractant that includes dodecan-12-olide. When placed in an Ash tree that is suffering from tissue damage, green leaf volatiles released by the Ash tree may combine with the released dodecan-12-olide to attract male EABs to the attractant.

In preferred embodiments, the present disclosure provides an attractant that includes dodecan-12-olide and a green leaf volatile, such as (3Z)-hexenol. A green leaf volatile is a volatile organic compound that is released when a plant suffers tissue damage. Green leaf volatiles include aldehydes, esters, and alcohols of 6-carbon compounds released after wounding or insect feeding. In the context of the current specification, green leaf volatiles refers to volatiles released by Ash trees. Other examples of green leaf volatiles that may be used in combination with dodecan-12-olide include: (2E)-hexenol, hexanal, (2E)-hexenal, and congeneric acetates of these alcohols.

The attractant may include a lure that releases the dodecan-12-olide and a source of green leaf volatile that releases the volatile organic compound. The source of green leaf volatile may be a vessel, such as a pouch, containing a volume of the green leaf volatile. The vessel is preferably made of polyethylene since polyethylene is not dissolved by the organic compound. Green leaf volatiles effuse through the polyethylene vessel and are released into the environment. The rate of effusion is dependent on, among other things, the surface area of the vessel and the thickness of the walls of the vessel. The walls of the vessel used to release the green leaf volatile may be from about 4 mils (that is 0.004 inches) to about 8 mils thick. The vessel containing the green leaf volatile is preferably sized and shaped to release the green leaf volatile at a rate from about 40 mg/day to about 400 mg/day. The walls are preferably 6 mils thick, which provides a release rate of the green leaf volatile that is from about 50 to about 100 mg/day, depending on the weather.

In attractants that either include or lack the green leaf volatile, the dodecan-12-olide may be dissolved in a carrier solvent and applied to the lure. One exemplary carrier solvent is dichloromethane. The dodecan-12-olide may be applied to the lure, such as a piece of rubber, resulting in a lure loaded with dodecan-12-olide. The lure may be made from the same natural rubber material as is used in rubber Suba•Seal™ septa. The natural rubber has a release rate that is substantially constant over time for several months under field conditions. Lures with a constant release rate are preferable to lures with an exponential or a first order release rate.

The lure may be treated with a sufficiently high concentration of dodecan-12-olide to result in a release rate of from about 20 to about 200 μg of dodecan-12-olide per day. In particular embodiments, the lure will have a release rate of from about 40 to about 120 μg of dodecan-12-olide per day. In still other particular embodiments, the lure will have a release rate of from about 50 to about 90 μg of dodecan-12-olide per day. In specific embodiments, the lure will have a release rate of from about 60 to about 80 μg of dodecan-12-olide per day.

In attractants that include the green leaf volatile, the attractant may include a lure loaded with sufficient dodecan-12-olide, and a source of sufficient green leaf volatile to release from (a) about 1 μg of dodecan-12-olide per about 5 mg of the green leaf volatile released, to (b) about 1 μg of dodecan-12-olide per about 0.1 mg of the green leaf volatile released. In particular embodiments, the attractant may release from about 1 μg of dodecan-12-olide per about 2 mg of the green leaf volatile released, to about 1 μg of dodecan-12-olide per about 0.25 mg of the green leaf volatile released. In still other particular embodiments, the attractant may release from about 1 μg of dodecan-12-olide per about 1.25 mg of the green leaf volatile released, to about 1 μg of dodecan-12-olide per about 0.5 mg of the green leaf volatile released.

Alternatively, the attractant may be a vessel containing a liquid mixture of the dodecan-12-olide and the green leaf volatile. As discussed above, the vessel is preferably made of polyethylene and the walls of the vessel may be from about 4 mils to about 8 mils thick. The rate of effusion of the dodecan-12-olide is dependent on the concentration of dodecan-12-olide in the mixture. The mixture may contain sufficient dodecan-12-olide mixed with the green leaf volatile to result in a release rate from the vessel of about 1 μg of dodecan-12-olide per about 5 mg of the green leaf volatile released, to about 1 μg of dodecan-12-olide per about 0.1 mg of the green leaf volatile released. In particular embodiments, the mixture may contain sufficient dodecan-12-olide to result in a release rate of from about 1 μg of dodecan-12-olide per about 2 mg of the green leaf volatile released, to about 1 μg of dodecan-12-olide per about 0.25 mg of the green leaf volatile released. In still other particular embodiments, the mixture may contain sufficient dodecan-12-olide to result in a release rate of from about 1 μg of dodecan-12-olide per about 1.25 mg of the green leaf volatile released, to about 1 μg of dodecan-12-olide per about 0.5 mg of the green leaf volatile released. The vessel containing the green leaf volatile is preferably sized and shaped to release the green leaf volatile at a rate from about 40 mg/day to about 400 mg/day.

In other embodiments, the present disclosure provides dodecan-12-olide for use as a sex pheromone analog for EABs. In still other embodiments, the present disclosure provides the use of dodecan-12-olide as a sex pheromone for EABs.

Using dodecan-12-olide as a sex pheromone analog may attract male EABs to a trap that includes the dodecan-12-olide. The trap may be, for example, a three-sided sticky prism trap, a Lindgren multifunnel trap, or another trap known in the art. Three-sided sticky prism traps are preferable as they provide a large surface on which the dodecan-12-olide may be applied. The trap may be green or purple, but green is preferred as green traps have been found to preferably capture males. The trap may preferably be suspended in the canopy of an Ash tree, for example from about 20 to about 40 feet above the ground. Preferably the trap is suspended about 30 feet above the ground. The trap may preferably be suspended on the south aspect of the tree.

In order to attract male EABs in a natural environment, it is desirable to release, on average, at least about 20 μg of dodecan-12-olide per day per attractant source. In particular embodiments, it is desirable to release, on average, at least about 40 μg of dodecan-12-olide per day per attractant source. In other particular embodiments, it is desirable to release, on average, at least about 60 pa of dodecan-12-olide per day per attractant source.

Dodecan-12-olide may be used to attract male EABs to a tree or other location that is not suitable for EAB spreading. For example, dodecan-12-olide may be used to attract male EABs to a non-host tree (i.e. a tree other than an Ash tree, such as a conifer tree). Mating and laying eggs in the non-host tree may be fatal to at least some of the resulting larva.

In yet other embodiments, the dodecan-12-olide may be used to overwhelm the receptors on male EAB antennae and reduce or disrupt the ability of the male EABs to locate a female EAB. Such a disruption may reduce the rate of EAB spreading, or reduce the rate of Ash tree mortality caused by the EABs.

In embodiments where it is desirable to overwhelm male EABs ability to locate a mate by substantially saturating the receptors of the male EABs, methods according to the present disclosure may use a plurality of high release-rate lures per tree, where each lure releases on average at least about 0.5 mg of dodecan-12-olide per day, and preferably from about 1 to about 10 mg of dodecan-12-olide per day. The method may use sufficient lures to result in 1 mg of dodecan-12-olide released per m³ of canopy volume per day. Alternatively, the methods may use a plurality of high release rate vessels, such as pouches, containing dodecan-12-olide. The vessel is preferably made of polyethylene since polyethylene is not dissolved by the dodecan-12-olide. The walls of the vessel used to release the dodecan-12-olide may be from about 4 mils to about 8 mils thick.

The present disclosure provides a method for attracting male EABs. Dodecan-12-olide may be applied to at least a portion of an Ash tree, to a non-host tree that is close to an Ash tree, in the canopy of an Ash tree, or any combination thereof. For example, the male EABs may be attracted to a trap, such as discussed above, having an attractant that includes the dodecan-12-olide where the trap is placed in the canopy of an Ash tree. In another example, an attractant that includes the dodecan-12-olide could be applied to a non-host tree. Attracting the male EABs may disrupt their ability to locate a mate. Such a disruption may reduce the rate of EAB spreading, or reduce the rate of Ash tree mortality caused by the EABs.

Dodecan-12-olide, or an attractant that includes dodecan-12-olide, may be used to disrupt EAB mating or to kill EABs in a “push-pull” method.

In an exemplary “push-pull” method, a number of Ash trees are masked from EAB detection, or EAB are repelled from the Ash trees, by applying a chemical stimulus on, in, or near the Ash trees. Simultaneously, an attractant that includes dodecan-12-olide and a green leaf volatile is used to attract EABs to a trap, or to another Ash tree on which, or in which, a systemic insecticide is applied. The insecticide may be azadirachtin, emamectin benzoate, imidacloprid, dinotefuran, permethrin, bifenthrin, cyfluthrin, carbaryl, or a combination thereof. Other insecticides known in the art may also be used. TreeAzin™ is an injectible commercial insecticide formulated with azadirachtin, an extract of neem tree seeds. Alternatively, the attractant may be used to attract EABs to a non-host tree.

While the method is conceptually straight-forward, it is not possible to predict which chemical stimuli will “push” the EAB toward the trap. The authors of the present disclosure believe that conifer volatiles could be used as chemical stimuli since EAB larva would not survive if laid in conifer trees. In particular examples, the volatiles from a spruce tree may be used. Examples of spruce tree volatiles that may be used as a masking agent in such a method include: α-pinene, β-pinene, 3-carene, limonene, α-terpinolene, or a combination thereof.

In another exemplary “push-pull” method, a trap is baited with an attractant that includes dodecan-12-olide and a green leaf volatile, such as (3Z)-hexenol. The trap is positioned in an Ash tree, as discussed above, and a plurality of high release-rate lures releasing dodecan-12-olide are positioned in the canopy of the Ash tree, preferably around the trap and preferably at about the same height as the trap. Alternatively, the trap is positioned in a non-host tree and a plurality of high release-rate lures releasing dodecan-12-olide are positioned in the canopy of an Ash tree close to the non-host tree. In particular examples, the high release-rate lures are polycaprolactone-based lures. High release-rate lures are lures that release at least about 0.5 mg dodecan-12-olide per day. In some examples, high release-rate lures release from about 1 to about 10 mg/day. Preferably, a sufficient number of high release-rate lures are used to result in 1 mg of dodecan-12-olide being released per m³ of canopy volume per day. Without wishing to be bound by theory, these high release rate disrupter lures are believed to disrupt EAB orientation since they lack the green leaf volatile, and the EABs are instead more attracted to the trap or non-host tree that is baited with an attractant that more closely mimics the natural attractant.

### Experimental Results

### Synthetic Chemistry

### (3Z)-Dodecen-12-olide

This compound was prepared as described by Silk et al. in 2011 (Silk P J, et al (2011) Evidence for a volatile pheromone in Agrilus planipennis Fairmaire (Coleoptera: Buprestidae) that increases attraction to a host foliar volatile. Env Entomol 40: 904-916). The synthesized (3Z)-dodecen-12-olide was >98% pure with ca. 2% of the E-isomer. The spectral data for the prepared compound corresponded to the data reported by Silk et al. in 2011.

### (3E)-Dodecen-12-olide

This compound was synthesized similarly to the Z-isomer, however, a modified Julia-Kocienski trans-olefination was used to introduce the E-olefin at position 3. The method is described by Silk et al. in 2011 and by MaGee et al. in 2013 (Magee D I, et al. (2013) Synthesis of (3E)-dodecen-12-olide, a potential pheromone component of the emerald ash borer. Synth Comm 43: 1368-1377). The synthesized (3E)-dodecen-12-olide was >98% pure with ca. 2% Z-isomer. The spectral data for the prepared compound corresponded to the data reported by MaGee et al. in 2013.

### Dodecan-12-olide

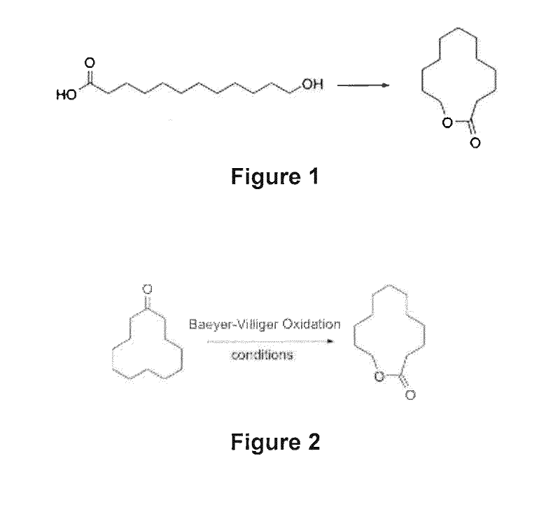

This compound was synthesized as illustrated in FIGS. 1 and 2. FIG. 1 illustrates the synthesis via Mitsunobu cyclization using the method reported by Boden et al. in 1993 (Boden C D, et al (1993) A concise, efficient and flexible strategy for the synthesis of the pheromones of Oryzaephilus and Cryptolestes grain beetles. Synthesis 4: 411-420). This method involves the Mitsunobu esterification of ω-hydroxyacid using PPh₃ and DIAD (diisopropyl azodicarboxylate) in toluene at RT. This method provided the dodecan-12-olide in a 55% yield and one step from the hydroxyacid.

FIG. 2 illustrates the synthesis via Baeyer-Villiger oxidation (BVO) of cyclododecanone. This method provides the dodecan-12-olide in one step. Reaction of cyclododecanone with meta-chloroperoxybenzoic acid (mCPBA, commercially available) provided the dodecan-12-olide. This reaction (Table 1, Entry 1), however, proved to be extremely slow; this was also reported by van der Mee et al. in 2006 (van der Mee L, et al (2006) Investigation of lipase-catalysed ring-opening polymerization of lactones with various ring sizes. Kin Evaluat Macromol 39: 5021-5027), who refluxed cyclododecanone and mCPBA in CH₂Cl₂ for 10 d and still reported incomplete consumption of cyclododecanone.

The authors of the present disclosure found that toluenesulfonic acid monohydrate-(TsOH.H₂O)-catalyzed mCPBA BVO of cyclododecanone proceeds with 99.8% completion in 3.5 wks. (Table 1, Entry 2). The use of basic conditions (2 equiv. of NaHCO₃ instead of a catalytic amount of TsOH.H₂O) gave 98% completion after 2.5 months (Table 1, Entry 1). A large-scale synthesis of dodecan-12-olide from cyclododecanone using mCPBA and a catalytic amount of TsOH.H₂O was conducted and dodecan-12-olide was obtained in 87% yield.

The more reactive trifluoroperoxyacetic acid (prepared in situ from trifluoroacetic anhydride and hydrogen peroxide) gave dodecan-12-olide from cyclododecanone in 11 d, 72% yield and with complete consumption of the starting material (Table 1, Entry 3). Also, the reagent Oxone® (potassium peroxymonosulfate, 2KHSO₅.KHSO₄.K₂SO₄) was completely inert toward cyclododecanone when stirred at RT in dichloromethane over 2 d, and magnesium monoperphthalate hexahydrate (MMPP)/NaHCO₃ only converted ˜0.5% of starting material cyclododecanone to product dodecan-12-olide when stirred at room temperature in 1:1 MeOH:H₂O over 1 d, and further stirring at this temperature produced no further conversion.

The reagent permaleic acid converts cyclododecanone to dodecan-12-olide in 1 d, and the authors of the present disclosure found that cyclododecanone is cleanly converted to dodecan-12-olide by stirring with a solution of permaleic acid in CH₂Cl₂ at RT for 5 d in 75% yield (Table 1, Entry 4).

TABLE 1
Baeyer-Villiger Oxidation (BVO) of cyclododecanone (see FIG. 2).

| | | | | Percentage Yield of |
|---|---|---|---|---|
| | Entry Conditions | Reaction Time | | dodecan-12-olide |
| 1 | 10 equiv. mCPBA, 2 equiv. | 2.5 | Months | 59^{a} |
| | NaHCO₃, CH₂Cl₂, RT. | | | |
| 2 | 2.1 equiv. mCPBA, 0.04 | 3.5 | Weeks | 87^{b} |
| | equiv. TsOH•H₂O, CH₂Cl₂, | | | |
| | RT | | | |
| 3 | 10 equiv. H₂O₂ (35 wt % | 11 | Days | 72^{c} |
| | aqueous), 31 equiv. | | | |
| | (CF₃CO)₂, 1 equiv. | | | |
| | Na₂HPO₄•7H₂O, | | | |
| | CH₂Cl₂, RT. | | | |
| 4 | Permaleic acid (generated in | 5 | Days | 75^{b} |
| | situ from maleic anhydride, | | | |
| | 35 wt % aqueous H₂O₂, and | | | |
| | acetic anhydride), CH₂Cl₂, | | | |
| | RT | | | |

^{a}~98% Consumption of ketone cyclododecanone by GC/MS.
^{b}~99.8% Consumption of ketone cyclododecanone by GC/MS.
^{c}100% Consumption of ketone cyclododecanone by GC/MS.

The spectral data for the prepared dodecan-12-olide corresponded to the data reported by Taber and Qui in 2013 (Taber D F, Qiu J (2013) Permaleic acid: Baeyer-Villiger oxidation of cyclododecanone. J Chem Educ 90: 1103-1104). The spectral data is: R_{f}=0.24 (1:20 EtOAc:hexanes). ¹H NMR (CDCl₃, 400 MHz): δ 4.12 (AA′XX′, 2H), 2.33 (AA′XX′, 2H), 1.60-1.66 (m, 4H), 1.27-1.41 (m, 14H). ¹³C NMR (CDCl₃, 100 MHz): δ 174.1, 64.5, 34.6, 27.4, 26.6, 26.4, 26.3, 25.35, 25.31, 24.9, 24.5, 24.2. IR (Neat, cm⁻¹): 2928 (m), 2859 (m), 1730 (s), 1361 (m), 1380 (w), 1334 (w), 1247 (m), 1173 (w), 1140 (m), 1096 (w), 1049 (w). MS (El, 70 eV) (main peaks): m/z 55 (base peak), 69, 83, 98, 110, 123, 125, 129, 138, 151, 162, 169, 180, 198 (M⁺). HMRS for dodecan-12-olide: ([C₁₂H₂₂NaO₂⁺] calc. 221.15133. found 221.1512, mass measurement error of −0.59 ppm).

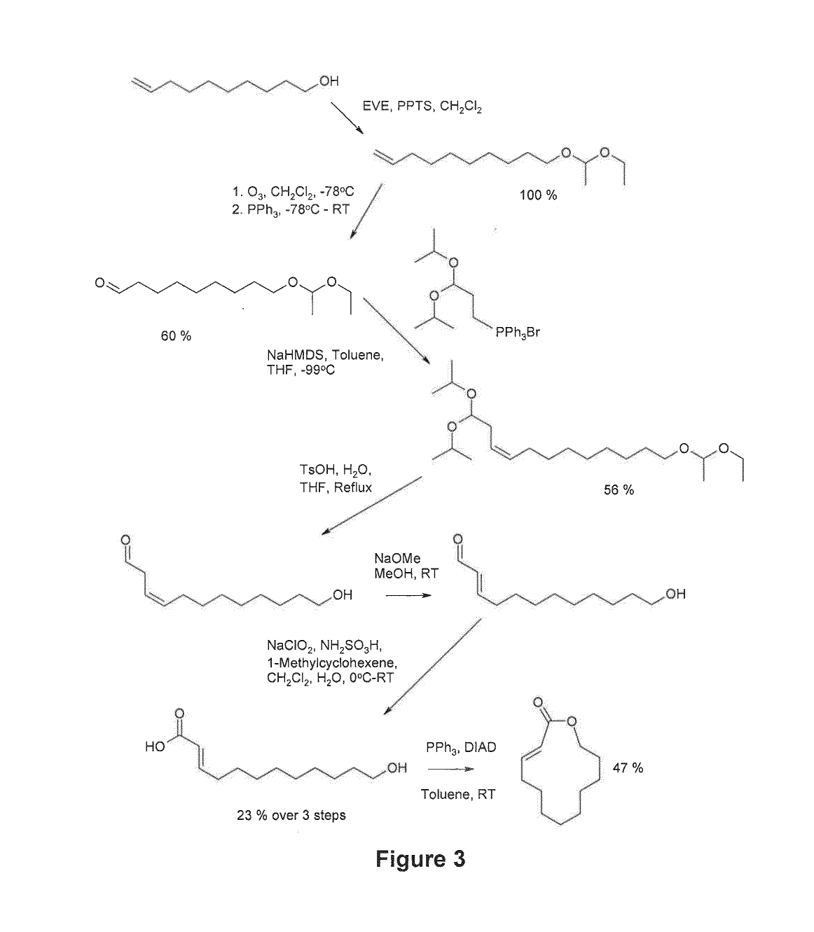

The pentadecan-15-olide was obtained from Sigma-Aldrich. The 2E-dodecen-12-olide was synthesized following the scheme shown in FIG. 3.

Experimental Insects.

Trees with larval EAB were felled in Lambton and Middlesex Counties, Ontario, and infested logs were transported to the Great Lakes Forestry Centre in Sault Ste. Marie, Ontario. Storage and rearing protocols have been previously reported by Silk et al. in 2009 (Silk P J, et al (2009) A contact sex pheromone component of the emerald ash borer Agrilus planipennis Fairmaire (Coleoptera: Buprestidae). Naturwissenschaften 96: 601-608). Emerged adults were kept on a 16:8 h L:D cycle and supplied with water and foliage of evergreen ash, Fraxinus uhdei (Wenzig) Linglesh. These insects were sent to the Atlantic Forestry Centre laboratory (Fredericton, New Brunswick) under a Canadian Food Inspection Agency movement certificate, placed in the quarantine facility, and used within 3-4 d.

Electroantennography.

Electroantennogram analyses (EAG) were conducted using methods and equipment generally described by Silk et al. in 2007 (Silk P J, et al (2007) Evidence for a male-produced pheromone in Tetropium fuscum (F.) (Coleoptera: Cerambycidae). Naturwissenschaften 94: 697-701). Antennae were excised close to the head and mounted using electrode gel (Spectra 360 electrode gel; Parker, Fairfield, N.J., USA) on an EAG probe (gold) for electrical contact. EAG signals were recorded using Syntech recording and analysis software v. 2.6 (Syntech, Hilversum, The Netherlands).

The (3Z)- and (3E)-lactones, and dodecan-12-olide were tested using the puff technique described by Silk et al. in 2011 (Silk P J, Ryall K, Mayo P, Lemay M, Grant G, Crook D, Cossé A, Fraser I, Sweeney J D, Lyons D B, Pitt D, Scarr T, Magee D (2011) Evidence for a volatile pheromone in Agrilus planipennis Fairmaire (Coleoptera: Buprestidae) that increases attraction to a host foliar volatile. Env Entomol 40: 904-916). Briefly: two microliters of serially diluted solutions (dichloromethane; DCM) of synthetic compounds were applied to filter paper strips (0.5 cm×5 cm, Whatman No. 1). The filter paper strips were placed in 14 cm long Pasteur pipettes, hereafter referred to as stimulus cartridges, after 5 min at room temperature. The stimulus dose tested was 1 μg. Male and female antennae were exposed to single 0.2 s puffs of odor-bearing air at 5 ml/s by placing the tip of a stimulus cartridge into a hole of a glass tube (0.7 cm ID×20 cm), 10 cm from the outlet and 11 cm away from the antennal preparation. Airflow through the glass tube was passed through a water bubbler and set at 10 ml/s. Each antennal preparation was tested with freshly prepared sets of stimuli cartridges using ˜6 male and ˜10 female antennae/treatment and used once for each treatment.

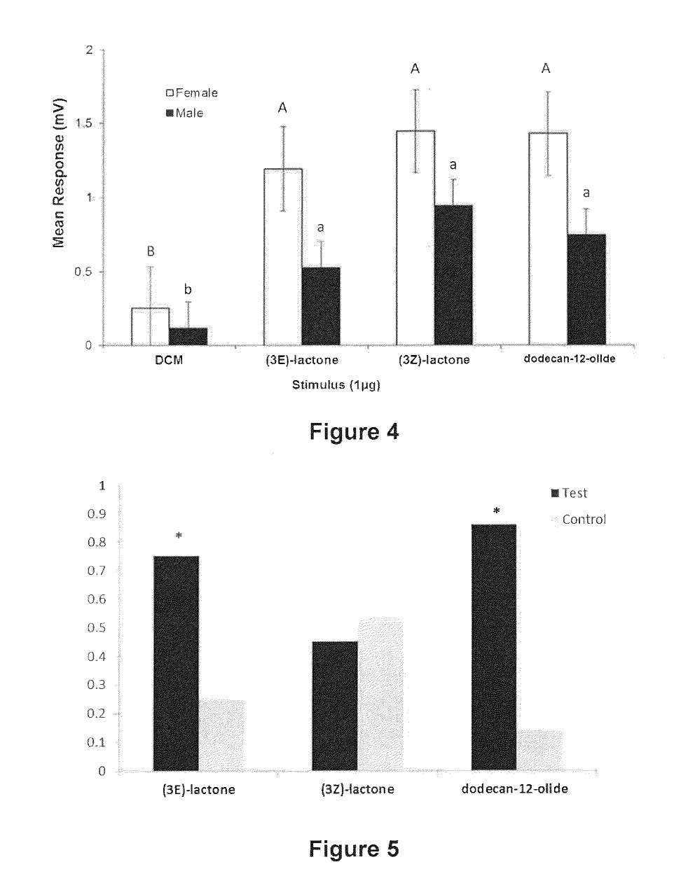

The mean responses of both male and female EAB antennae to the (3Z)-lactone, the (3E)-lactone, and dodecan-12-olide (1 μg source concentration) were not significantly different (P<0.05; Tukey's), but were significantly greater than those to the solvent control (dichloromethane) stimulus. The results are illustrated in FIG. 4, which shows mean EAG responses of male and female EAB to the compounds±standard error.

Two-Choice Olfactometer Bioassays.

A Y-tube olfactometer (Analytical Research Systems Inc, Micanopy, Fla., USA) was used to test for short-range attraction of adult EAB to the lactones. The glass olfactometer (1.5 cm i.d.) had an 11-cm main stem that branched into two 9-cm arms. Each arm was connected to a cylinder that contained the stimulus. Charcoal-filtered air was passed into each arm at a flow rate of 1.2 L/min. Treatments were 1 μg each of (3Z)-lactone, (3E)-lactone, and dodecan-12-olide. Each stimulus was diluted in dichloromethane, placed on a strip of filter paper, and given 1 min for the solvent to evaporate before being placed in the olfactometer. A filter paper with only solvent (control) was placed in the other arm of the olfactometer. The apparatus was rinsed with acetone after each treatment, and the arm attached to the test stimulus was randomized between replicates. For each trial, a single EAB (male or female) was given 10 min to choose between the two stimuli. A choice was recorded when the beetle passed a “finish line”, 7 cm beyond the branching point of each arm. “No choice” was recorded if the beetle failed to pass either finish line after the 10 min. Beetles were 8-14 d old, and 18-23 beetles were used per treatment.

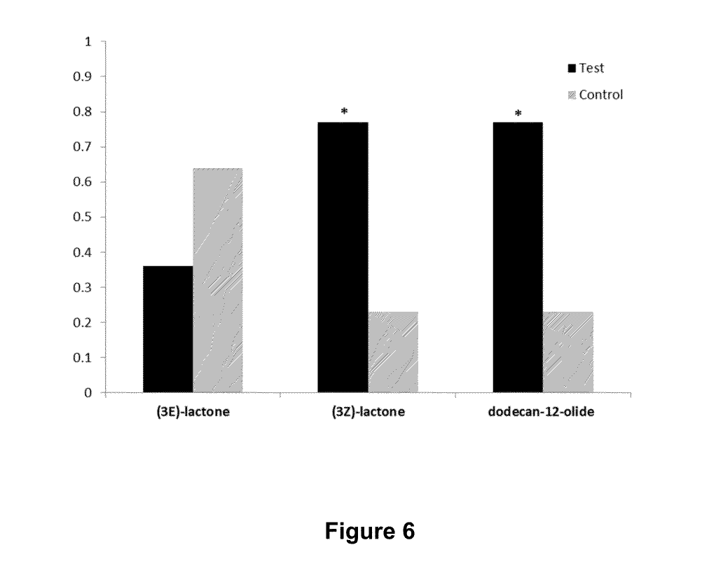

In the Y-tube olfactometer assay at the dosages tested, males were significantly attracted to (3E)-lactone (χ2=4; df=1; P=0.046) but not attracted to the (3Z)-lactone (χ2=1; df=1; P=0.347). The opposite was true for females, which were somewhat attracted to the (3Z)-lactone (χ2=3.77; df=1; P=0.052) but not to the (3E)-lactone (χ2=0; df=1; P=1). Both sexes were attracted to dodecan-12-olide (χ2=4; df=1; P=0.046). Among both females and males, there was a high proportion that made no choice in the olfactometer (˜50%). The results are illustrated in FIG. 5, which shows the results for the males, and in FIG. 6, which shows the results for the females. The y-axis indicates the proportion of the beetles that chose that arm. For example the results from the (3E)-lactone indicate that about 75% chose the stimulus, and about 25% chose the control. A chi-square goodness of fit test was used to test whether the ratio of beetles choosing the stimulus vs. the hexane control differed significantly from 1:1; * represents significant differences.

Field Trapping Studies.

Three trapping experiments were conducted to test the effects of (3Z)-lactone and dodecan-12-olide on mean captures of EAB on dark green sticky prism traps using protocols discussed by Francese et al. in 2010 (Francese J A, Crook D J, Fraser I, Lance D A, A. J. Sawyer A J, Mastro V C (2010a) Optimization of trap color for the emerald ash borer, Agrilus planipennis (Coleoptera: Buprestidae). J Econ Entomol 103: 1235-1241) co-baited with (3Z)-hexenol. Urban street trees were used: trees were 20-40 cm in diameter, and 10-16 m in height. Blocks were chosen based on the proximity of known infested trees at low to moderate densities; trees used for the trapping experiment showed few obvious signs or symptoms of infestation. Dark green prism sticky traps (0.30×25.00×58.75 cm) (Synergy Semiochemicals Corp., Burnaby, British Columbia) were used in all field trials. Traps were spaced˜25 m apart, and lure treatments replicated in a randomized complete block design. Traps were deployed using either a limb hook over a lower to mid-canopy branch or a single rope over a mid-canopy branch. In both years, traps were checked every 2 wk and all EAB were collected, counted, and sexed.

Traps were baited with one of three treatments: 1) (3Z)-hexenol alone; 2) 3.0 mg dose of (3Z)-lactone+(3Z)-hexenol; or 3) dodecan-12-olide+(3Z)-hexenol. The dodecan-12-olide dose was 3.0 mg or 5.0 mg. A higher dose of the analog was used to attempt to increase its effect on captures of EAB relative to the (3Z)-lactone. (3Z)-Lactone and the analog were each loaded onto rubber septa lures (Wheaton Scientific, Millville, N.J.). (3Z)-Hexenol lures were obtained from Synergy Semiochemicals. Release rates of the 3.0 mg (3Z)-lactone, 3.0 mg and 5.0 mg dodecan-12-olide lures, and (3Z)-hexenol were ˜66 μg/d, ˜60 μg/d and ˜80 μg/d. These values were determined as in Silk et al. 2011, and 50-100 mg/d (by weight loss), respectively, at 25° C. The (3Z)-lactone and analog lures were estimated to maintain sustained and almost constant release rates for a minimum of 6 wk, and thus were not replaced during the experiment. Similarly, (3Z)-hexenol lures were not replaced during the experiment.

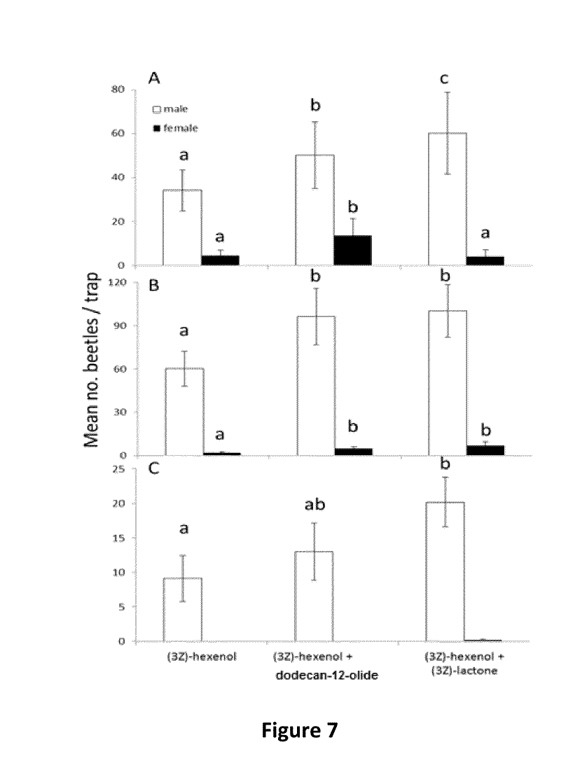

Mean catch of male EAB varied significantly among the three treatment trials (χ2=81.19, df=2, P<0.001) (χ2=62.51, df=2, P<0.001) and (χ2=42.135, df=2, P<0.001), as illustrated in FIG. 7. The dose of the tested compounds was the same in the results shown in FIG. 7a (3 mg per lure). The dose of the dodecan-12-olide was higher (5 mg per lure) than the dose of the (3Z)-lactone (3 mg per lure) in the results shown in FIGS. 7b and 7c. The treatment was replicated 11 times in the results shown in FIG. 7a, and replicated 12 times the results shown in FIGS. 7b and 7c.

In two of three trials, traps baited with (3Z)-hexenol+dodecan-12-olide captured significantly more male EAB than traps baited with (3Z)-hexenol alone (FIGS. 7a and 6b). Similarly, in two of three trials, where the dose of the dodecan-12-olide 5 mg per lure, mean catch of EAB was not significantly different between traps baited with (3Z)-hexenol+dodecan-12-olide versus (3Z)-hexenol+(3Z)-lactone (FIGS. 7b and 6c).

In the trial where the traps all used 3 mg of compound per lure, traps baited with (3Z)-hexenol+dodecan-12-olide captured approximately 50 male beetles while traps baited with (3Z)-hexenol+(3Z)-lactone captured approximately 60 male beetles (FIG. 7a). Dodecan-12-olide is about 85% as active in these trials as the natural (3Z)-lactone under comparable conditions.

Mean catch of female EAB also varied significantly among the three treatments in two of the three trials (χ2=80.693, df=2, P<0.001) and (χ2=22.271, df=2, P<0.001). Too few females (two) were captured in the results shown in FIG. 7c for analysis. In the results shown in FIG. 7a, significantly more females were captured on traps baited with dodecan-12-olide compared with the other two treatments. In the results shown in FIG. 7b, more females were captured on traps baited with either dodecan-12-olide or (3Z)-lactone compared with (3Z)-hexenol alone (FIG. 7b; P<0.01); similar numbers of females were captured on traps baited with dodecan-12-olide vs. (3Z)-lactone (P=0.102).

Trap Placement.

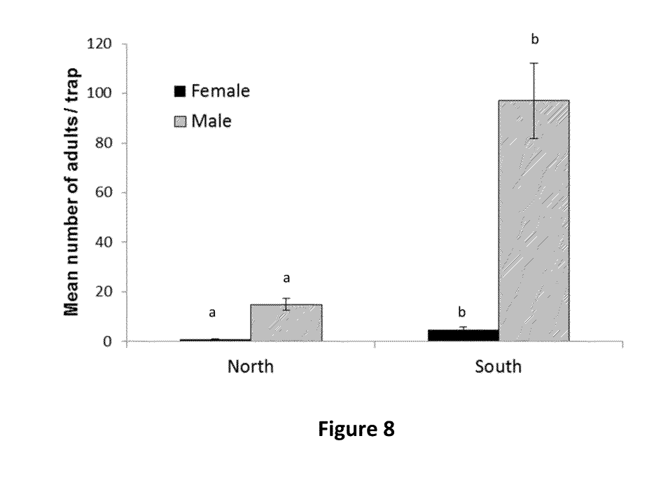

The location of the trap was tested by deploying dark green sticky prism traps in the canopy, on the north and south aspects of the same tree. Each trap was baited with 3.0 mg (3Z)-lactone and (3Z)-hexenol in low-moderate density EAG populations. The results are illustrated in FIG. 8, which indicate that traps placed in the south aspect show increased trapping of both male and female EABs. In the context of the present disclosure, the term “south aspect” should be understood to refer to a position that is within 30° from due south. Similarly, the term “north aspect” should be understood to refer to a position that is within 30° from due north.

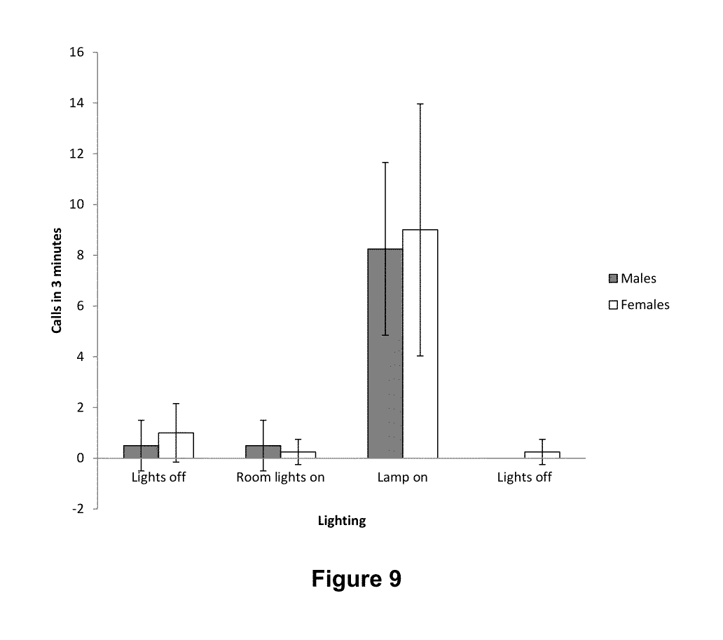

These results may be due to the increased amount of light falling on the south facing traps since the tested trees were in the northern hemisphere. Different light conditions were tested for EAB behaviours that are referred to as “calling behaviours,” which are behaviours performed by EAB males leading up to mating. The results are illustrated in FIG. 9, which show that lamps, but not fluorescent lights, increase the number of calls by both male and female EABs. Given the broad spectra of incandescent and halogen lamps, in comparison to the narrow peaks in the spectra for fluorescent lights, these data suggest that placing traps in a sunny location in the tree would increase the number of EABs attracted to the trap.

Push-Pull Trial.

A trial was performed to identify whether EABs could be pulled towards a trap baited with (3Z)-hexenol and (3Z)-lactone, while being pushed away from high release-rate lures that release only the (3Z)-lactone. Three groups of traps were studied in 13 replications: (A) control-only, where the trap was baited with (3Z)-hexenol alone; (B) attractant-only, where the trap was baited with (3Z)-hexenol and (3Z)-lactone; and (C) attractant and disrupter; where the trap was baited with (3Z)-hexenol and (3Z)-lactone and the trap was surrounded by high release rate disrupter lures releasing (3Z)-lactone only.

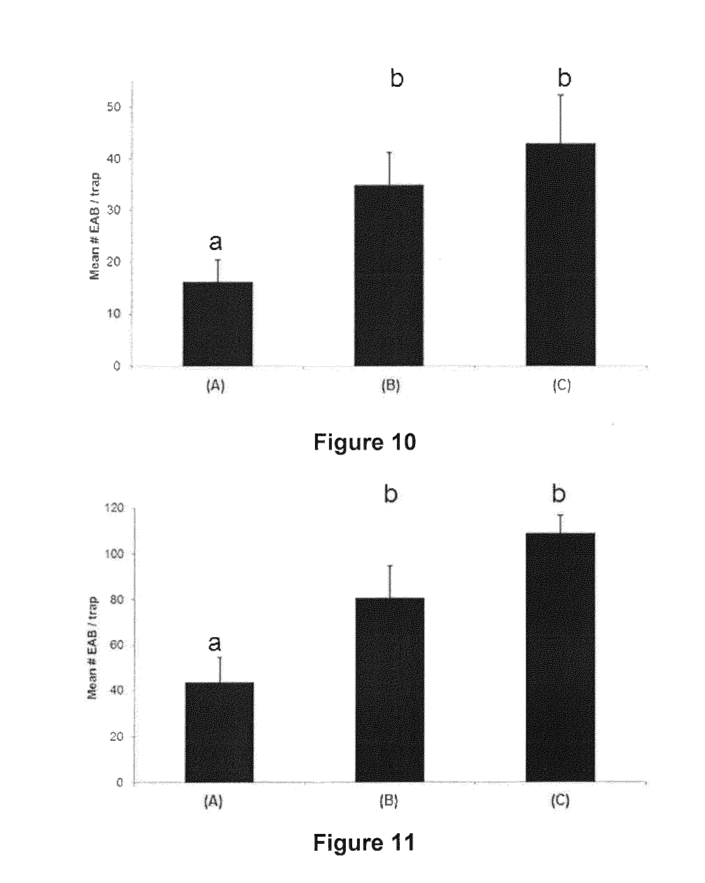

The results illustrated in FIG. 10 show the total captures using four high release rate disrupter lures. The results illustrated in FIG. 11 show the total captures using seven high release rate disrupter lures. Increasing the number of high release-rate lures proportionally increased the number of EABs captured. In view of the results discussed above, the authors of the present disclosure predict that dodecan-12-olide could be used as a replacement for the (3Z)-lactone.

Non-Host Volatile as Masking Compound.

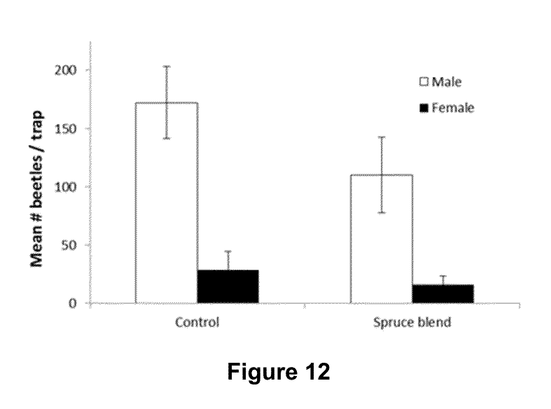

A trial was performed to identify whether a blend of volatile spruce compounds could be used to reduce the attraction of traps baited with (3Z)-hexenol and (3Z)-lactone. The blend of volatile compounds included: α-pinene, β-pinene, 3-carene, limonene, and α-terpinolene. Control traps baited with (3Z)-hexenol and (3Z)-lactone, and test traps baited with (3Z)-hexenol and (3Z)-lactone but masked with the blend of spruce compounds, were placed in Ash tree canopies. The numbers of EABs captured per trap were measured. The results are illustrated in FIG. 12, which shows that trap captures for male EABs were significantly reduced on traps masked with the blend of spruce compounds (t=3.151, df=9, P=0.012), as compared to the control traps baited (using a paired t-test on captures). This reduction was not observed for females EABs (t=1.588, df=9, P=0.147). The authors of the present disclosure believe that any one of the volatiles could be used separately as a masking compound.

Statistical Analysis.

For the EAG results, male and female EAG responses were submitted to analysis of variance (ANOVA) and mean responses to each of the tested compounds separated using Tukey's test (P<0.05). For the olfactometer study, a chi-square goodness of fit test used to test whether the ratio of beetles choosing the stimulus vs. the hexane control differed significantly from 1:1 (Minitab); beetles that did not select either the stimulus or the control (i.e., no choice) were excluded from the analysis. Finally, in the trapping study, numbers of male and female EAB captured among the three treatments were analyzed separately by fitting generalized linear mixed effect models, with block as a random factor, to the Poisson distribution (GLMER function, R Development Core Team 2013). Chi-square tests were used to determine if a significant proportion of the variation in capture of male and female EAB was attributable to treatment. Chi-square tests were considered significant at P=0.05 or less and, if significant, the means separated using the Tukey's contrast option in the GLHT function (R Development Core Team 2013); raw data are presented as means±standard error.

In the preceding description, for purposes of explanation, numerous details are set forth in order to provide a thorough understanding of the embodiments. However, it will be apparent to one skilled in the art that these specific details are not required. Accordingly, what has been described is merely illustrative of the application of the described embodiments and numerous modifications and variations are possible in light of the above teachings.

Since the above description provides example embodiments, it will be appreciated that modifications and variations can be effected to the particular embodiments by those of skill in the art. Accordingly, the scope of the claims should not be limited by the particular embodiments set forth herein, but should be construed in a manner consistent with the specification as a whole.

### REFERENCES

BARTELT R, COSSÉ A A, ZILKOWSKI B W, FRASER I (2007) Antennally active macrolide from the emerald ash borer Agrilus planipennis emitted predominantly by females. J Chem Ecol 33: 1299-1302
BODEN C D, CHAMBERS J, STEVENS I D R (1993) A concise, efficient and flexible strategy for the synthesis of the pheromones of Oryzaephilus and Cryptolestes grain beetles. Synthesis 4: 411-420
CAPPAERT D, MCCULLOUGH D G, POLAND T M, SIEGERT N W (2005) Emerald ash borer in North America: a research and regulatory challenge. Am Entomol 51: 152-165
COOK S M, KHAN Z R, PICKETT J A (2007) The use of push-pull strategies in integrated pest management. Annu Rev Entomol 52: 375-400
CROOK D J, MASTRO V C (2010) Chemical ecology of emerald ash borer Agrilus planipennis. J Chem Ecol 36: 101-112
CROOK D J, KRIMIAN A, FRANCESE J, FRASER I, POLAND T M, SAWYER A J, MASTRO, V (2008) Development of a host-based semiochemical lure for trapping emerald ash borer Agrilus planipennis (Coleoptera: Buprestidae). Envrion Entomol 37: 356-365
DE GROOT P, GRANT G G, POLAND T M, SCHARBACH R, BUCHAN L, NOTT R W, MACDONALD L, PITT D (2008) Electrophysiological response and attraction of emerald ash borer to green leaf volatiles (GLVs) emitted by host foliage. J Chem Ecol 34: 1170-1179
DICKENS J C, JANG E B, LIGHT D M, ALFORD A R (1990) Enhancement of insect pheromone responses by green leaf volatiles. Naturwissenschaften 77: 29-31
DOMINGUE M J, BAKER T C (2012) A multi-disciplinary approach for developing tools to monitor invasive buprestid beetle species. In: Blanco J J, Fernandes A T (eds) Invasive species: threats, ecological impact and control methods. Nova, Hauppauge, N.Y., pp. 77-100
EAB (2014) Emerald ash borer information website. http://www.emeraldashborer.info/faa.cfm Accessed May 2014
FÃRCASIU D, JÄHME J, RÜCHARDT C (1985) Relative reactivity at bridgehead adamantyl and homoadamantyl substrates from solvolysis with heptafluorobutyrate as a highly reactive carbohydrate leaving group. Absence of S_{N}2 character of solvolysis of tert-butyl derivatives. J Am Chem Soc 107: 5717-5722
FRANCESE J A, CROOK D J, FRASER I, LANCE D A, A. J. SAWYER A J, MASTRO V C (2010a) Optimization of trap color for the emerald ash borer, Agrilus planipennis (Coleoptera: Buprestidae). J Econ Entomol 103: 1235-1241
FRANCESE J A, MASTRO V C, OLIVER J B, LANCE D R, YOUSEFF N, LAVALEE S G (2005) Evaluation of colors for trapping Agrilus planipennis (Coleoptera: Buprestidae). J Entomol Sci 40:93-95
GRANT G G, RYALL K L, LYONS D B, ABOU-ZAID M M (2010) Differential response of male and female emerald ash borers (Col., Buprestidae) to (Z)-3-hexenol and manuka oil. J Appl Entomol 34: 26-33
HAACK R A, JENDEK E, LUI H, MARCHANT K R, PETRICE T, POLAND T M, YE H (2002) The emerald ash borer: a new exotic pest in North America. Newsl Mich Entomol Soc 47: 1-LELITO J P, FRASER I, MASTRO V, TUMLINSON J H, BOROCZKY K, BAKER T C (2007) Visually mediated ‘paratrooper copulations’ in the mating behaviour of Agrilus planipennis (Coleoptera: Buprestidae), a highly destructive invasive pest of North American ash trees. J Insect Behav 20: 537-552
LELITO J P, FRASER I MASTRO V, TUMLINSON J H, BAKER T C (2008) Novel visual-cue-based sticky traps for monitoring of emerald ash borers, Agrilus planipennis (Col., Buprestidae). J Appl Entomol 132: 668-674
LELITO J P, BÖRÖCZKY K, JONES T H, FRASER I, MASTRO V C, TUMLINSON J H, BAKER T C (2009) Behavioral evidence for a contact sex pheromone component of the emerald ash borer, Agrilus planipennis Fairmaire. J Chem Ecol 35: 104-110
LEMMEN J, EVENDEN M (2009) Peripheral and behavioral plasticity of pheromone response and its hormonal control in a long-lived moth. J Exp Biol 212: 2000-2006
MAGEE D I. MAYO P D, SILK P J, BEATTIE B (2013) Synthesis of (3E)-dodecen-12-olide, a potential pheromone component of the emerald ash borer. Synth Comm 43: 1368-1377
MAYO P D, SILK P J, MAGEE D I, MCCONAGHY J (2014) Concise synthesis of (3Z)-dodecen-12-olide, pheromone component of the emerald ash borer. Synth Comm 44: 1957-1969
MCCULLOUGH D G, MERCADER R J (2012) Evaluation of potential strategies to slow ash mortality (SLAM) caused by emerald ash borer (Agrilus planipennis): SLAM in an urban forest. Int Journal Pest Manage 58: 9-23
MINO T, MASUDA S, NISHIO M, YAMASHITA M (1997) Synthesis of lactones by Baeyer-Villiger oxidation with magnesium monoperphthalate hexahydrate. J Org Chem 62: 2633-2635
NEHME M, KEENA M, ZHANG A, BAKER T, XU Z, HOOVER K (2010) Field testing of Anoplophora glabripennis male-produced pheromone and plant volatiles. Environ Entomol 39: 169-176
R Development Core Team (2013) R: a language and environment for statistical computing. R Foundation for Statistical Computing, Vienna, Austria. ISBN 3-900051-07-0. Available from http://www.R-project.org (accessed 2014)
PURESWARAN D S, POLAND T M (2009) The role of olfactory cues in short-range mate finding by the emerald ash borer, Agrilus planipennis, Fairmaire (Coleoptera: Cerambycidae). J Insect Behav 22: 205-216
RODRIGUEZ-SAONA C, POLAND T M, MILLER J R, STELINSKI L L, GRANT G G, D E GROOT P, BUCHAN L, MACDONALD L (2006) Behavioural and electrophysiological responses of the emerald ash borer, Agrilus planipennis, to induced volatiles of Manchurian Ash, Fraxinus mandshurica. Chemoecology 16: 75-86
REINECKE A, RUTHER J, MAYER C J, HILKER M (2006) Optimized trap lure for male Melolontha cockchafers. J Appl Entomol 130: 171-176
RUTHER J, REINECKE A, HILKER M (2002) Plant volatiles in the sexual communication of Melolontha hippocastan: response towards time-dependent bouquet and novel function of (Z)-3-hexen-1-ol as a sexual kairomone. Ecol Entomol 27: 76-83
RUTHER J, REINECKE A, THIEMANN K, TOLASCH T, FRANCKE W, HILKER M (2000) Mate finding in the forest cockchafer, Melolontha hippocastani, mediated by volatiles from plants and females. Physiol Entomol 25: 172-179
RYALL K, SILK P J, MAYO P M, CROOK D, KRIMIAN, A. COSSÉ A, SWEENEY J, SCARR T (2012) Attraction of Agrilus planipennis Fairmaire (Coleoptera: Buprestidae) to a volatile pheromone: effects of release rate, host volatile and trap placement. Environ Entomol 41: 648-656
RYALL K, FIDGEN J G, SILK P J, SCARR T A (2013) Efficacy of the pheromone (3Z)-lactone and the host kairomone (3Z)-hexenol at detecting early infestation of the emerald ash borer, 15 Agrilus planipennis. Entomol Experimen Appl 147: 126-131
SIEGERT N W, MCCULLOUGH D G, LIEBHOLD A M, TELEWSKI F W (2014) Dendrochronological reconstruction of the epicentre and early spread of emerald ash borer in North America. Divers Distrib 20: 847-858
SILK P J, RYALL K (2014) Semiochemistry and chemical ecology of the emerald ash borer Agrilus planipennis (Coleoptera: Buprestidae). Can Entomol doi:10.4039/tce.2014.58
SILK P J, SWEENEY J D, WU J, PRICE J, GUTOWSKI J, KETTELA E G (2007) Evidence for a male-produced pheromone in Tetropium fuscum (F.) (Coleoptera: Cerambycidae). Naturwissenschaften 94: 697-701
SILK P J, RYALL K, LYONS B, SWEENEY J D, WU J (2009) A contact sex pheromone component of the emerald ash borer Agrilus planipennis Fairmaire (Coleoptera: Buprestidae). Naturwissenschaften 96: 601-608
SILK P J, RYALL K, MAYO P, LEMAY M, GRANT G, CROOK D, COSSÉ A, FRASER I, SWEENEY J D, LYONS D B, PITT D, SCARR T, MAGEE D (2011) Evidence for a volatile pheromone in Agrilus planipennis Fairmaire (Coleoptera: Buprestidae) that increases attraction to a host foliar volatile. Env Entomol 40: 904-916
SUGINOME H, YAMADA S (1985) Photoinduced transformations, 77. A four-step substitution of a carbonyl group of steroidal ketones by an oxygen atom. a new method for the synthesis of cyclic ethers. J Org Chem 50: 2489-2494
TABER D F, QIU J (2013) Permaleic acid: Baeyer-Villiger oxidation of cyclododecanone. J Chem Educ 90: 1103-1104
SWEENEY, J., D E GROOT, P., PRICE, J., & GUTOWSKI, J. M. (2006). Effect of semiochemical release rate, killing agent, and trap design on detection of Tetropium fuscum (F.) and other longhorn beetles (Coleoptera: Cerambycidae). Environmental Entomology, 35, 645-654.
VAN DER MEE L, HELMICH F, DE BRUIJN R, VEKEMANS JAJM, PALMANS ARA, MEIJER E W (2006) Investigation of lipase-catalysed ring-opening polymerization of lactones with various ring sizes. Kin Evaluat Macromol 39: 5021-5027
WERMUTH C G, GANELLIN C R, LINDBERG P, MITSCHER L A (1998) Glossary of terms used in medicinal chemistry (IUPAC Recommendations 1998). Pure Appl Chem 70 (5): 1129-1143
XU P, GARCZYNSK, S F, ATUNGULU E, SYED Z, CHOO Y-M, VIDAL D M, ZITELLI C H, LEAL, W S (2012) Moth sex pheromone receptors and deceitful parapheromones. PLOS One 7: 1-9

What is claimed is:

1. A method of reducing or disrupting the ability of male Emerald Ash borers (EABs) to locate a mate, the method comprising:
administering a composition that comprises dodecan-12-olide to at least a portion of an Ash tree, in the canopy of an Ash tree, or any combination thereof.

2. The method according to claim 1, wherein the Ash tree is infested with EABs, or at risk of infestation with EABs.

3. The method according to claim 1 or 2, wherein the administering comprises applying the composition comprising the dodecan-12-olide to at least a portion of the canopy of the Ash tree.

4. The method according to any one of claims 1-3, wherein sufficient dodecan-12-olide is administered to substantially saturate the receptors of male EABs in the Ash tree.

5. The method according to claim 1 or 2, wherein the administering comprises placing a high release-rate lure or vessel comprising dodecan-12-olide in the canopy of the Ash tree.

6. The method according to claim 5, wherein the high release-rate lure or vessel releases the dodecan-12-olide at a rate of at least about 0.5 mg/day.

7. The method according to claim 5 or 6, wherein a sufficient number of high release-rate lures or vessels are placed in the canopy of the Ash tree to substantially saturate the receptors of male EABs in the Ash tree.

8. A method of attracting a male Emerald Ash borer (EAB), the method comprising:
placing an attractant comprising dodecan-12-olide and a green leaf volatile in a canopy of an Ash tree, or in or near a non-host tree.

9. The method according to claim 8, wherein the Ash tree is infested with EABs, or at risk of infestation with EABs.

10. The method according to claim 8 or 9, wherein the green leaf volatile is (3Z)-hexenol, (2E)-hexenol, hexanal, (2E)-hexenal, (3Z)-hexenyl acetate, (2E)-hexenyl acetate, or any combination thereof.

11. The method according to any one of claims 8-10, wherein the attractant comprises a lure formulated to release dodecan-12-olide at a rate from about 20 to about 200 μg of dodecan-12-olide per day, and a vessel containing the green leaf volatile sized and shaped to release the green leaf volatile at a rate from about 40 mg/day to about 400 mg/day.

12. The method according to claim 11, wherein the attractant comprises a lure formulated to release dodecan-12-olide at a rate from about 40 to about 120 μg of dodecan-12-olide per day, and a vessel containing the green leaf volatile sized and shaped to release the green leaf volatile at a rate from about 40 mg/day to about 400 mg/day.

13. The method according to claim 11, wherein the attractant comprises a lure formulated to release dodecan-12-olide at a rate from about 50 to about 90 μg of dodecan-12-olide per day, and a vessel containing the green leaf volatile sized and shaped to release the green leaf volatile at a rate from about 40 mg/day to about 400 mg/day.

14. The method according to claim 11, wherein the attractant comprises a lure formulated to release dodecan-12-olide at a rate from about 60 to about 80 μg of dodecan-12-olide per day, and a vessel containing the green leaf volatile sized and shaped to release the green leaf volatile at a rate from about 40 mg/day to about 400 mg/day.

15. The method according to any one of claims 8-10, wherein the attractant comprises a vessel containing a liquid mixture of the dodecan-12-olide and the green leaf volatile.

16. The method according to any one of claims 11-15, wherein the vessel is a polyethylene vessel.

17. The method according to any one of claims 11-16, wherein the walls of the vessel are 4-8 mils thick.

18. The method according to any one of claims 8-17, wherein the attractant includes dodecan-12-olide and green leaf volatile in sufficient amounts to result in a release of:
(a) about 1 μg of dodecan-12-olide per about 5 mg of the green leaf volatile released, to
(b) about 1 μg of dodecan-12-olide per about 0.1 mg of the green leaf volatile released.

19. The method according to claim 18, wherein the attractant includes dodecan-12-olide and green leaf volatile in sufficient amounts to result in a release of:
(a) about 1 μg of dodecan-12-olide per about 2 mg of the green leaf volatile released, to
(b) about 1 μg of dodecan-12-olide per about 0.25 mg of the green leaf volatile released.

20. The method according to claim 18, wherein the attractant includes dodecan-12-olide and green leaf volatile in sufficient amounts to result in a release of:
(a) about 1 μg of dodecan-12-olide per about 1.25 mg of the green leaf volatile released, to
(b) about 1 μg of dodecan-12-olide per about 0.5 mg of the green leaf volatile released.

21. The method according to any one of claims 8-20, wherein the attractant is associated with a trap.

22. The method according to claim 21, wherein the trap is positioned in the canopy of the Ash tree.

23. The method according to claim 22, wherein the trap is positioned from about 20 to about 40 feet above the ground.

24. The method according to claim 22 or 23, wherein the trap is positioned on the south aspect of the tree.

25. The method according to any one of claims 8-24, wherein the Ash tree is treated with an insecticide.

26. The method according to claim 25, wherein the insecticide is a trunk-injected systemic insecticide, systemic trunk spray insecticide, or a protective cover insecticide.

27. The method according to claim 25, wherein the insecticide is: azadirachtin, emamectin benzoate, imidacloprid, dinotefuran, permethrin, bifenthrin, cyfluthrin, carbaryl, or a combination thereof.

28. The method according to any one of claims 8-20, wherein the attractant is placed in the canopy of the non-host tree.

29. The method according to claim 28, wherein the attractant is associated with a lure or a trap that is positioned in the canopy of the non-host tree.

30. The method according to claim 28 or 29, wherein the attractant is positioned from about 20 to about 40 feet above the ground.

31. The method according to any one of claims 28-30, wherein the attractant is positioned on the south aspect of the tree.

32. The method according to any one of claims 8-31, further comprising:
placing a plurality of high release-rate lures or vessels that comprise dodecan-12-olide in the canopy of the Ash tree, or in the canopy of an Ash tree close to the non-host tree.

33. The method according to claim 32, wherein the high release-rate lures or vessels release the dodecan-12-olide at a rate of at least about 0.5 mg/day.

34. The method according to claim 33, wherein a sufficient number of high release-rate lures or vessels are placed in the canopy of the Ash tree to substantially saturate the receptors of male EABs in the Ash tree.

35. The method according to claim 34, wherein the high release-rate lures or vessels release 1 mg of dodecan-12-olide per m³ of canopy volume per day.

36. The method according to any one of claims 8-31, further comprising:
applying a composition comprising a masking agent to at least a portion of one or more Ash trees that lack the attractant, wherein the Ash trees that lack the attractant are infested with EABs, or are at risk of infestation with EABs.

37. The method according to claim 36, wherein the masking agent comprises a volatile compound from a conifer tree.

38. The method according to claim 37, wherein the conifer tree is a spruce tree.

39. The method according to claim 38, wherein the masking agent comprises: α-pinene, β-pinene, 3-carene, limonene, α-terpinolene, or a combination thereof.

40. The method according to any one of claims 1-39, wherein the method: reduces the rate of Emerald Ash borer (EAB) spreading through a population of Ash trees that are infested with EABs, or are at risk of infestation with EABs; reduces the rate of Ash tree mortality caused by EABs; or both.

41. An attractant comprising:
dodecan-12-olide, and
a green leaf volatile.

42. The attractant according to claim 41, wherein the green leaf volatile is: (3Z)-hexenol, (2E)-hexenol, hexanal, (2E)-hexenal, (3Z)-hexenyl acetate, (2E)-hexenyl acetate, or any combination thereof.

43. The attractant according to claim 41 or 42, wherein the attractant comprises a lure formulated to release dodecan-12-olide at a rate from about 20 to about 200 μg of dodecan-12-olide per day, and a vessel containing the green leaf volatile sized and shaped to release the green leaf volatile at a rate from about 40 mg/day to about 400 mg/day.

44. The attractant according to claim 43, wherein the attractant comprises a lure formulated to release dodecan-12-olide at a rate from about 40 to about 120 μg of dodecan-12-olide per day, and a vessel containing the green leaf volatile sized and shaped to release the green leaf volatile at a rate from about 40 mg/day to about 400 mg/day.

45. The attractant according to claim 43, wherein the attractant comprises a lure formulated to release dodecan-12-olide at a rate from about 50 to about 90 μg of dodecan-12-olide per day, and a vessel containing the green leaf volatile sized and shaped to release the green leaf volatile at a rate from about 40 mg/day to about 400 mg/day.

46. The attractant according to claim 43, wherein the attractant comprises a lure formulated to release dodecan-12-olide at a rate from about 60 to about 80 μg of dodecan-12-olide per day, and a vessel containing the green leaf volatile sized and shaped to release the green leaf volatile at a rate from about 40 mg/day to about 400 mg/day.

47. The attractant according to claim 41 or 42, wherein the attractant comprises a vessel containing a liquid mixture of the dodecan-12-olide and the green leaf volatile.

48. The attractant according to any one of claims 43-47, wherein the vessel is a polyethylene vessel.

49. The attractant according to any one of claims 43-48, wherein the walls of the vessel are 4-8 mils thick.

50. The attractant according to any one of claims 41-49, wherein the attractant includes dodecan-12-olide and green leaf volatile in sufficient amounts to result in a release of:
(a) about 1 μg of dodecan-12-olide per about 5 mg of the green leaf volatile released, to
(b) about 1 μg of dodecan-12-olide per about 0.1 mg of the green leaf volatile released.

51. The attractant according to claim 50, wherein the attractant includes dodecan-12-olide and green leaf volatile in sufficient amounts to result in a release of:
(a) about 1 μg of dodecan-12-olide per about 2 mg of the green leaf volatile released, to
(b) about 1 μg of dodecan-12-olide per about 0.25 mg of the green leaf volatile released.

52. The attractant according to claim 50, wherein the attractant includes dodecan-12-olide and green leaf volatile in sufficient amounts to result in a release of:
(a) about 1 μg of dodecan-12-olide per about 1.25 mg of the green leaf volatile released, to
(b) about 1 μg of dodecan-12-olide per about 0.5 mg of the green leaf volatile released

53. The attractant according to any one of claims 41-52:
a) for use as an attractant in an Emerald Ash borer (EAB) detection survey;
b) for use in reducing or disrupting the ability of male EABs to locate a mate;
c) for use in reducing the rate of EAB spreading through a population of Ash trees;
d) for use in reducing the rate of Ash tree mortality caused by EABs;
e) for use in attracting the EABs to a trap;
f) for use in attracting the EABs to an Ash tree treated with a systemic insecticide;
g) for use in attracting the EABs to a non-host tree; or
h) any combination thereof.

54. Dodecan-12-olide for use:
a) in reducing or disrupting the ability of male EABs to locate a mate;
b) in reducing the rate of EAB spreading through a population of Ash trees;
c) in reducing the rate of Ash tree mortality caused by EABs;
d) in disrupting male EAB orientation;
e) in increasing the capture rate of a trap baited with an attractant according to any one of claims 41-52; or
f) any combination thereof.

55. A high release-rate vessel or lure comprising dodecan-12-olide.

56. The high release-rate vessel or lure according to claim 55, wherein the vessel or lure is formulated to release dodecan-12-olide at a rate greater than 0.5 mg of dodecan-12-olide per day.

57. The high release-rate vessel or lure according to claim 56, wherein the vessel or lure is formulated to release dodecan-12-olide at a rate from about 1 mg to about 10 mg of dodecan-12-olide per day.

58. The high release-rate vessel or lure according to any one of claims 55-57, wherein the lure is a polycaprolactone-based lure.

59. The high release-rate vessel or lure according to any one of claims 55-57, wherein the vessel is a polyethylene vessel.

60. The high release-rate vessel or lure according to claim 59, wherein the walls of the vessel are 6 mils thick.
